(19) United States
(12) Patent Application Publication
(10) Pub. No.: US 2009/0147837 A1
(43) Pub. Date: Jun. 11, 2009

(54) WIRELESS SYSTEM SYNCHRONIZATION USING FREQUENCY SHIFT MODULATION AND ON-OFF KEYING MODULATION

(76) Inventor: Eddie LAU, Hong Kong (CN)

Correspondence Address: WANG & HO, 66 HILLTOP ROAD, MILLINGTON, NJ, 07946, US

(21) Appl. No.: 12/327,973

(22) Filed: Dec. 4, 2008

Related U.S. Application Data
(60) Provisional application No. 61/012,155, filed on Dec. 7, 2007.

(51) Int. Cl. H04B 1/38

(52) U.S. Cl. 375/219

(57) ABSTRACT

A system and method of wireless communication, in which both OOK and FSK modulation transceivers are used for communication among participating devices. On-Off Key (“OOK”) may be used to awaken a communication device, establish a communication channel, and handle transmission and reception of the control signal. In doing so, communication devices operating according to the invention may use less power than conventional communication devices. Once certain initial data is exchanged between communication devices, Frequency Shift Keying (“FSK”) may be used to provide the ability for many users to communicate in a more secure fashion, so that sensitive information, such as voice and data, may be transmitted between communication devices. In this manner, the privacy of data and voice signals may be more securely protected and transmitted by the FSK modulated signal.

### CROSS REFERENCE TO RELATED APPLICATIONS

This application claims benefit of U.S. Provisional Patent No. 61/012,155, filed Dec. 7, 2007, the contents of which are incorporated herein in its entirely by reference.

### FILED OF THE INVENTION

This invention relates to a wireless communication system and devices thereof. More particularly, it relates to a wireless communication system and devices thereof that combine frequency shift modulation and on-off keying modulation as the synchronized communication means.

### BACKGROUND OF THE INVENTION

Conventionally, wireless communication systems employ either one of the two common modulation methods: FSK (frequency shift key modulation) or OOK (on/off key modulation). For example, GSM (Global System for Mobile communications, or originally Groupe Special Mobile) mobile phones, Bluetooth headsets, digital cordless phones and walkie talkies, and others, adopt FSK modulation to carry binary ones and zeros for data and voice application. On the other hand, systems or devices requiring low data rate communication, for example, remote monitoring systems or keyless accessing devices, make use of OOK modulation to transfer small pieces of information between devices by means of sending radio frequency On-Off power pulses to represent binary ones and zeros.

Eisenberg et al. described a communication system for “robust, short range” radio communications between battery operated devices. Although the patent title used the phrase “combined OOK-FSK/PPM modulation and communication protocol scheme,” the center frequency of the system's local oscillator is not frequency modulated, only transmitted data is encoded by different rate of periodic signal. It may be more accurately described as “combined use of OOK modulation and FSK/PPM encoding communication protocol” because in this system FSK is applied to the data field as a kind of encoding, and there is no frequencey modulation to the carrier frequency. In other words, Eisenberg uses only OOK as modulation scheme to the RF carrier for establishing and maintaining wireless connection for communication, while using FSK/PPM for encoding communication contents, not for modulating the RF carrier frequency to carry information in the wireless connection. In essence, there is only a single OOK modulator to the carrier in the Eisenberg system although the data information are further encoded by a different on-off frequency rate.

Communication systems using either an OOK modulation transceiver or an FSK modulation transceiver alone for establishing and maintaining wireless connection and communication have drawbacks in different aspects. For example, devices with FSK modulation uses too much power while those with OOK is less secure to interference. The present invention address these problems by mixing both OOK and FSK modulation schemes for the process of establishing and maintaining connection in a single communication system.

### SUMMERY OF THE INVENTION

One object of the present invention is to provide a method of establishing and maintaining wireless connection for communication among wireless devices by employing a combination of two modulation schemes, OOK and FSK. By doing so, advantages from each modulation scheme may be exploited, and weaknesses in each modulation scheme may be minimized, if not eliminated. Consequently, the invention permits an improved communication system that has improved battery life, device synchronization, system time alignment, security of data transfer, group privacy and public broadcasting capability. Furthermore, two communication devices may communicate in digital signals with each other without the use of a base station.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described preferred embodiments of the invention.

### BRIEF DESCRIPTION OF THE DRAWINGS

FIG. 1 is a block diagram for a mobile terminal according to the present invention.

FIG. 2 is a block diagram of a receiver of FIG. 1, showing an implementation combining OOK and FSK according to the present invention.

FIG. 3 illustrates a frame architecture that may be used in a system according to the present invention, being an exemplary TDD system separating transmit and receive slot in time domain.

FIG. 4 illustrates a slot architecture that may be used in a system according to the present invention.

FIG. 5 is a Venn diagram illustrating interoperability between different groups of users in a system according to the present invention.

### DETAILED DESCRIPTION OF PARTICULAR EMBODIMENTS OF THE INVENTION

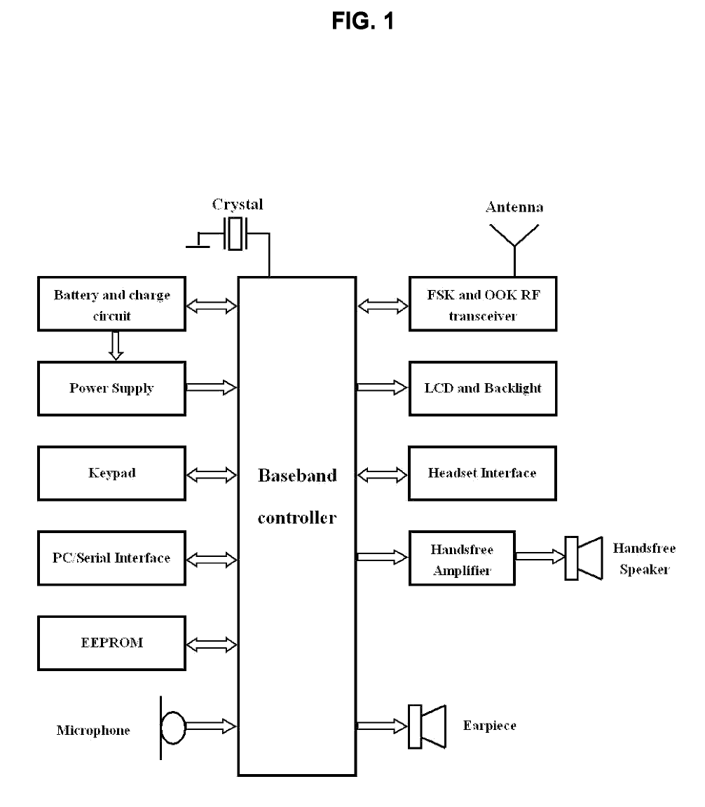

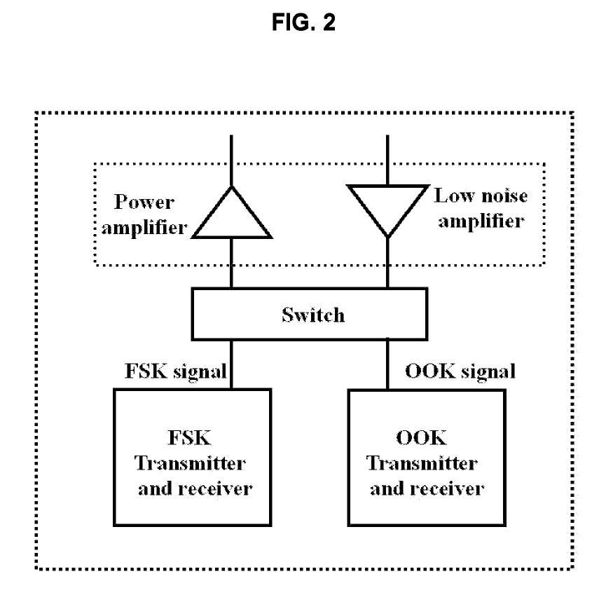

FIG. 1 schematically depicts a communication device according to the invention. Such a communication device has an FSK-OOK transceiver, which is shown in greater detail in FIG. 2. Additional details are provided below, explaining how in an exemplary way the transmission and reception of the control signal is accomplished using the OOK transceiver, while the transmission and reception of more sensitive information, such as voice, video and/or message data, may be accomplished using FSK modulation coding protocol and the FSK transceiver.

When it is desired to have two communication devices communicate with each other, a connection must be established between those two devices. In one embodiment of the invention, during connection establishment, transmission is initiated by a first communication device, for example a mobile terminal. To establish a communication connection, the first communication device may send an OOK control signal. The OOK control signal may include On-Off radio frequency power pulses for transmitting the following information: (a) one or more synchronization pulses, (b) the group name, (c) the user name, and (d) channel information. Data sent via the OOK modulated signal by the first communication device may be sent as a public message, which could be accessed by unauthorized receivers of the OOK pulses.

A second communication device at “sleep” state may receive the OOK signal. Upon receiving the OOK signal from the first communication device, the second communication device can be caused to move from a “sleep” (or power saving mode) state to an “active” state by the OOK radio frequency power pulse. Upon entering the active state, the second communication device may begin to decode the OOK signal and also send an acknowledgment to the first communication device. The acknowledgement may be sent as an OOK modulated signal. In this manner the two communication devices may engage in a “handshake”, and thereby establish that further communications are to occur between the two communication devices.

Upon completing handshake using OOK modulation, microprocessors in the participating communication devices will activate their respective FSK receivers from a “sleep” mode to a standby mode so that the communication devices are ready to send and receive FSK modulated signals on the channel identified by the earlier OOK modulated handshake signal. In this manner, the FSK transceiver remains in a low-power “sleep” state until needed, consuming less power. Thus the time between charging of the device's battery (or replacement of the battery) is extended because the FSK receiver is not in an active mode until needed, and the relatively lower-power OOK transmitter is used to provide a minimum required data transfer.

A listen-before-transmit algorithm may be implemented based on control signals of both OOK and FSK receiver output. For example, when a transmitter in one of the communication devices is ready to transmit information, the device (through the algorithm) may first check for an available time allocated for transmitting by analyzing the OOK modulated control signals from the other device. For example, an available time slot for transmitting information via FSK may be indicated by preceding the time slot with a predetermined number of zeros in the OOK signal. When the predetermined number of zeros is received from the OOK signal, the communication device will understand that an available time slot is about to occur, and that transmission could occur in the frames of the available time slot.

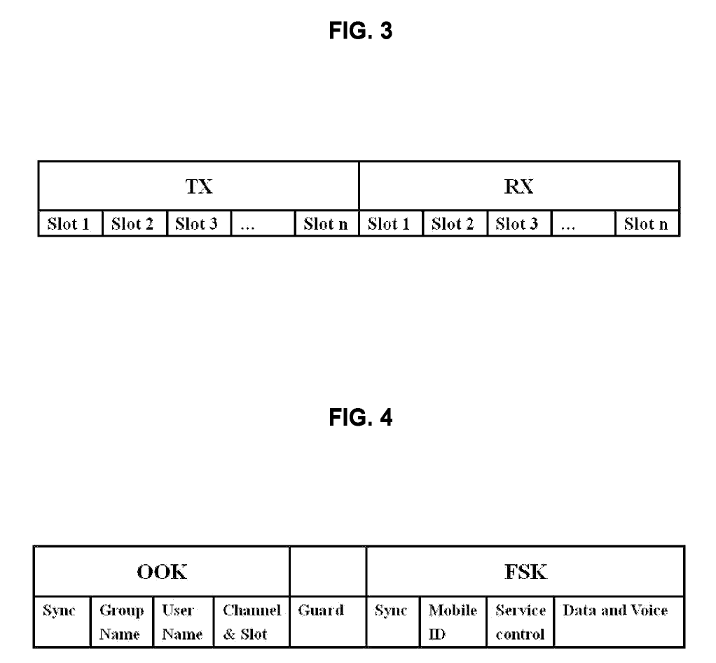

FIG. 3 illustrates an exemplary frame architecture that may be used in the present invention. The illustration is made from the point of view of one of the participating communication devices. When a connection is established between two devices, each device is allowed to transmit in one of the TX slots, and receive in one of the RX slots, in alternate order.

When no unoccupied time slot is available, the communication device which desires to transmit information will search for a channel that is likely to have the least interference. During the search for a low-interference channel, the microprocessor may analyze all channels in the look-up table, which is equal in size to the number of frequency channels multiplied by the number of time slots in a frame, in order to find a channel that is likely to have the least interference. Received data with similar packet types would be interpreted as occupied and transmission would not take place at that particular physical channel.

The OOK modulated signal of the OOK transceiver may also be used to align the system clock of the receiving communication device. By recording the OOK modulated power signal length, the receiving communication device aligns the frame cycle to other systems in order to optimize user capacity.

Fast synchronization of the devices may be achieved using the OOK modulated signal. For example, the device upon receiving the modulated OOK signal could be synchronized just after two frame cycles by following the allocated physical channel in the OOK data field.

However, if the OOK channel is busy, synchronization could follow conventional FSK demodulation algorithms by checking for a known valid FSK data pattern within a lookup table. Such a method of synchronization would take a number of frames “N”, wherein N is the number of frequency channels multiplied by the number of time slots.

FIG. 3 depicts a suitable frame architecture and FIG. 4 depicts a slot architecture that may be used to implement the invention. The “Group Name” and the “User Name” identified in FIG. 4 are the group name and user name of the sending device. The “Channel & Slot” identified for the OOK signal carries information which specifies the frequency channel and time slot that can be used to carry the upcoming FSK information. In this manner, the OOK public channel may be used by the receiving device to link at once to the correct FSK channel without going through a trial-and-error search.

When a connection is established between two devices, each device is permitted to transmit in one of the TX slots and receive in one of the RX slots. It will be recognized that each slot provides an initial synchronization pulse followed by the group name and user name of the device that is sending channel/slot information (which specifies which frequency channel and which time slot would be used to carry the upcoming FSK information) and a guard period, following which the FSK modulated signal will be sent on the identified channel. So, by obtaining the information provided by the OOK signal, the receiver can link to the correct FSK channel quickly without searching by trial-and-error. The FSK modulated signal may include a synchronization pulse, followed by a mobile identifier, a service control and then the voice, video and/or message data information, if the communication device is mobile phone terminal.

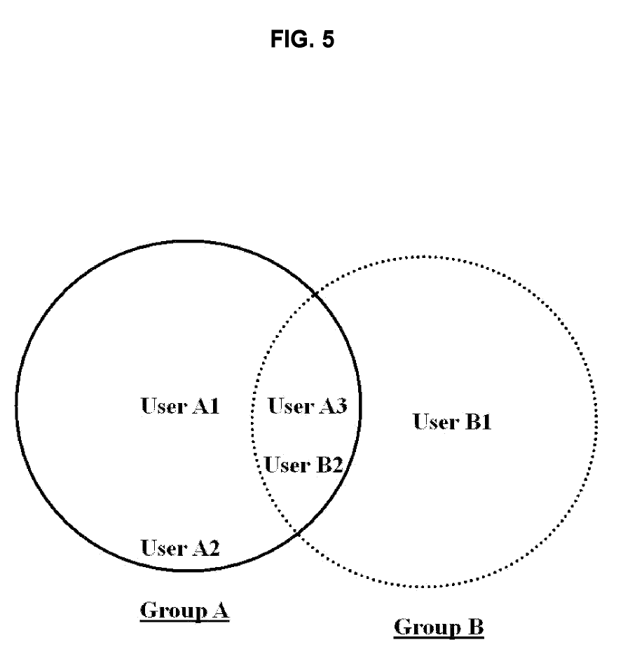

FIG. 5 depicts a Venn diagram, which illustrates the interoperability between different groups of users in a system according to the invention. While maintaining high security between two different groups of users by means of protected FSK data, time synchronization between the individual groups is still possible by means of the OOK public channel. As shown in FIG. 5, User A1 and User B1 are the hosts of groups A and B, respectively. The hosts maintain the system time synchronization by receiving valid OOK information that is sent by users within the group or outside the group. For example, User A1 “listens” to User A2 and User A3 as well as User B2 in order to ensure the groups are in synchronization to maximize system capacity.

Data provided by the OOK modulated signal can be made available to authorized as well as unauthorized users. However, in order to communicate by FSK modulated signals, a communication device first needs to be authenticated. Authentication may occur using the group name, user name, a unique device identification and/or other coding that is compared against a database of authorized users.

While there have been described and pointed out fundamental novel features of the invention as applied to a preferred embodiment thereof, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claim is:

1. A wireless communication device, comprising
(a) an OOK transceiver;
(b) a FSK transceiver;
(c) a switch;
(d) an antenna; and
(e) a micro-controller, wherein both said OOK transceiver and FSK transceiver are connected to said switch and then further to said antenna.

2. The wireless communication device of claim 1, wherein said micro-controller comprising an algorithm coordinating said OOK transceiver and FSK transceiver.

3. The wireless communication device of claim 2, wherein said algorithm is capable of determining a channel and a time slot from information provided by said OOK transceiver, which is available for further communication through said FSK transceiver.

4. The wireless communication device of claim 1, wherein said OOK transceiver handles transmission and reception of control signals and said FSK transceiver handles transmission and reception of a secured communication content.

5. The wireless communication device of claim 1, which is a mobile phone handset.

6. A communication system, comprising at least two wireless communication devices of claim 1.

7. A method of wireless communication, comprising the steps of:
(a) using an OOK transceiver to send a control signal to initiate a communication between two or more wireless communication devices; and
(b) using an FSK transceiver to communicate a secured content using a channel and time slot indicated in control signal from OOK transceiver

8. The method of claim 7, wherein said control signal is to awaken a communication device and establish a communication channel between participating communication devices.

9. The method of claim 8, wherein said secured content is text, image, audio or video data.

10. The wireless communication device of claim 1, which is a digital walkie-talkie set.
